(19) United States
(12) Patent Application Publication
(10) Pub. No.: US 2009/0050774 A1
(43) Pub. Date: Feb. 26, 2009

(54) Micro-optical bench and method of fabricating micro-optical bench

(76) Inventors: Menelaos K. Poutous, Charlotte, NC (US); James T. A. Carriere, Charlotte, NC (US)

Correspondence Address: DIGITAL OPTICS CORPORATION, C/O LEE & MORSE, P.C., 3141 FAIRVIEW PARK DRIVE, SUITE 500, FALLS CHURCH, VA, 22042, US

(21) Appl. No.: 11/892,578

(22) Filed: Aug. 24, 2007

(51) Int. Cl. G01M 11/04; B05D 3/02

(52) U.S. Cl. 248/467; 248/466; 427/385.5

(57) ABSTRACT

A micro-optical bench may include a substrate having a substantially planar surface on which an optical element is to be mounted, and two lithographs protruding above the substantially planar surface adapted to position and restrain movement of the optical element.

### FIELD OF THE INVENTION

Embodiments are directed to micro-optical benches and methods of fabricating micro-optical benches. More particularly, embodiments are directed to passive alignment optical micro-benches for out-of-plane optics and methods of fabricating such a micro-optical bench.

### BACKGROUND OF THE INVENTION

Micro-optical benches, i.e., optical motherboards, may be used to precisely align optical fibers and/or other components, e.g., lenses, detectors, lasers, etc. More particularly, e.g., micro-optical benches may be used for passive alignment of out-of-plane optical components and/or alignment of optical fiber waveguides. Micro-optical benches are generally formed using dry etching and/or wet etching techniques. For example, a silicon optical bench (SiOB) may be formed by anisotropically wet-etching silicon substrates, with various crystal orientations, in accordance with a desired sidewall angle.

The use of, e.g., silicon substrates and/or wet etching methods may, however, be limiting. For example, silicon substrates, which are opaque and do not transmit light, may not be useful in visible light applications. Also, e.g., wet etching methods, which progress along crystal planes of a substrate, generally only enable certain sidewall angles to be formed due to an orientation of the crystal planes with respect to a crystal growth axis thereof. Additionally, wet etching methods of silicon substrates may be limited to one or two different aspect ratios due to the relatively large topography of the remaining substrate. Therefore, the positional orientation of optical components on the SiOB may be limited by the crystallographic orientation of the substrate.

In some cases, dry etching methods have been employed to form optical benches, e.g., anisotropically dry etching polycrystalline substrates to form optical benches. However, forming sidewalls, e.g., wells, for positioning of micro-optics on the substrate may involve deep etches, e.g., greater than about 50 μm, may be difficult using lithographic techniques. Further, due to the nature of dry-etching processes, surface quality at, e.g., a bottom surface of the well may be poor, e.g., rough. As a result of such roughness, an optical element to be positioned at least partially within the well may not be positioned properly, and thus, alignment of the optical element with respect to the substrate and/or other elements on the optical bench may not be proper.

### SUMMARY OF THE INVENTION

Embodiments are therefore directed to optical benches for out-of-plane optical component(s) and methods of forming optical benches for out-of-plane optical component(s), which substantially overcome one or more of the problems due to the limitations and disadvantages of the related art. More particularly, embodiments are therefore directed to micro-optical benches for out-of-plane optical element(s) and methods of forming micro-optical benches for out-of-plane optical element(s), which substantially overcome one or more of the problems due to the limitations and disadvantages of the related art.

It is therefore a feature of an embodiment of the present invention to provide a micro-optical bench that is free of positional orientation restrictions.

It is therefore a separate feature of an embodiment of the present invention to provide a method of forming a micro-optical bench that is free of positional orientation restrictions.

It is therefore a separate feature of an embodiment of the present invention to provide a micro-optical bench including a transmissive substrate.

It is therefore a separate feature of an embodiment of the present invention to provide a method of forming a micro-optical bench including a transmissive substrate.

It is therefore a separate feature of an embodiment of the present invention to provide a method of forming a micro-optical bench without requiring etching of the substrate thereof.

It is therefore a separate feature of an embodiment of the present invention to provide a micro-optical bench including positioning projections on a surface thereof for passively aligning optical components with the positioning projections.

It is therefore a separate feature of an embodiment of the present invention to provide a method of forming a micro-optical bench including positioning projections on a surface thereof for passively aligning optical components with the positioning projections.

At least one of the above and other features and advantages of the present invention may be realized by providing a micro-optical bench, including a substrate having a substantially planar surface on which an optical element is to be mounted, and two lithographs protruding above the substantially planar surface adapted to position and restrain movement of the optical element.

The two lithographs may define a footprint for the optical element.

When the optical element is on the substrate, each of the lithographs may abut the optical element. Each of the lithographs may abut opposing faces of the optical element. Each of the lithographs may abut adjacent faces of the optical element.

The two lithographs may include a plurality of lithographs, each lithograph may abut a different face of the optical element adjacent the substrate. Two lithographs of the plurality of lithographs may abut each different face of the optical element adjacent the substrate.

The two lithographs may allow the optical element to be positioned in at least two rotational positions. Each lithograph may be adjacent to one side of the optical element at each rotational position. The two lithographs may be made of a polymer or a polymerizing vitreous material. The two lithographs may be integral with the substrate. The substrate may be transparent to wavelengths of interest.

The optical element may be optically connected through the substrate. The substrate may include a plurality of substantially planar surfaces on which corresponding optical elements are to be mounted, and the two lithographs may include two lithographs adjacent each of the corresponding optical elements. The plurality of substantially planar surfaces may form a continuous substantially planar surface.

At least one of the lithographs may have one of a circular cross-sectional shape, an oval cross-sectional shape and a polygonal cross-sectional shape. An adhesive layer may be arranged between the substrate and the optical element.

The micro-optical element may include a second substrate overlapping at least a portion of the substrate and spaced apart from the substrate by a predetermined distance corresponding to a height of bonding spacers arranged between the substrate and the second substrate, wherein the second substrate may include a substantially planar surface on which an optical element is to be mounted.

The two lithographs may include a plurality of lithographs and at least one of the plurality of lithographs may project a further distance away from the substrate than others of the plurality of lithographs.

At least one of the above and other features and advantages of the present invention may be separately realized by providing a method of manufacturing an optical bench, including cleaning a surface of a substrate, priming the cleaned surface of substrate for photopolymer application, coating the primed surface of the substrate with a photopolymer layer, exposing a portion of the photopolymer layer based on a position of at least two positioning projections to be formed on the substrate, the positioning projections being positioned so as to define a predetermined space on the optical bench where an optical element is to be mounted, curing and developing the photopolymer layer to form the at least two positioning projections, and thermally treating the at least two positioning projections.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1A illustrates a plan view of a first exemplary embodiment of an optical bench in a state in which an optical element is being positioned thereon;

FIG. 1B illustrates a top plan view of the first exemplary embodiment of the optical bench of FIG. 1A without an optical element positioned thereon;

FIG. 1C illustrates a plan view of the first exemplary embodiment of the optical bench of FIG. 1A in a state in which the optical element is positioned thereon;

FIG. 2A illustrates a cross-sectional view of a second exemplary embodiment of an optical bench in a state in which a plurality of optical elements are positioned thereon;

FIG. 2B illustrates a top plan view of the second exemplary embodiment of the optical bench of FIG. 2A;

FIG. 3 illustrates a cross-sectional view of a third exemplary embodiment of an optical bench in a state in which a plurality of optical elements are positioned thereon;

FIG. 4 illustrates a top plan view of an exemplary surface showing exemplary configurations of positioning projections; and

FIG. 5 illustrates a flow chart of stages in an exemplary process of forming an optical bench.

### DETAILED DESCRIPTION

Embodiments will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the concept of the invention to those skilled in the art.

In the drawings, the thickness of layers and regions may be exaggerated for clarity. It will also be understood that when a layer is referred to as being “on” another layer or substrate, it may be directly on the other layer or substrate, or intervening layers may also be present. Further, it will be understood that when a layer is referred to as being “under” another layer, it may be directly under, or one or more intervening layers may also be present. In addition, it will also be understood that when a layer is referred to as being “between” two layers, it may be the only layer between the two layers, or one or more intervening layers may also be present. Like numbers refer to like elements throughout the specification.

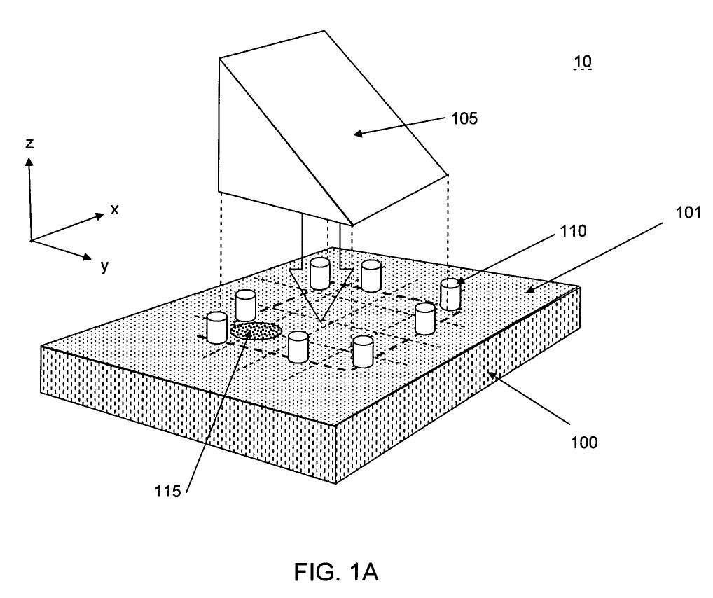

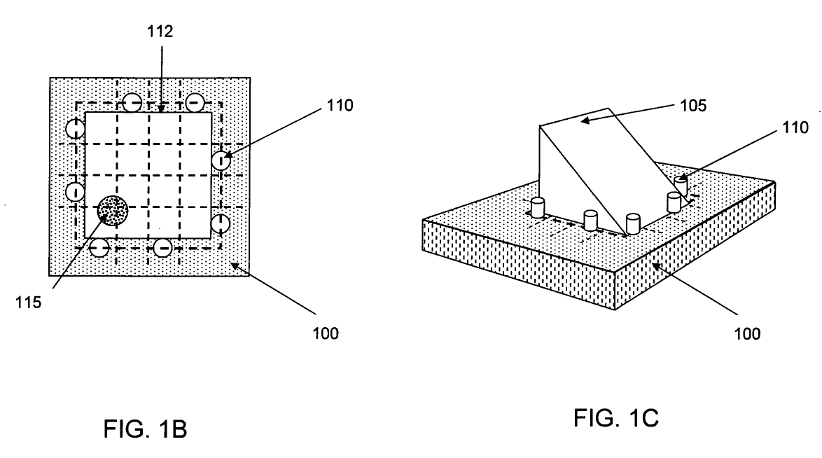

FIG. 1A illustrates a plan view of a first exemplary embodiment of an optical bench 10 in a state in which an optical element is being positioned thereon, FIG. 1B illustrates a top plan view of the first exemplary embodiment of the optical bench 10 of FIG. 1A without an optical element positioned thereon, and FIG. 1C illustrates a plan view of the first exemplary embodiment of the optical bench 10 of FIG. 1A in a state in which the optical element is positioned thereon.

Referring to FIG. 1A, the optical bench 10 may include a substrate 100 with a plurality of positioning projections 110 and optical element(s), e.g., a micro-prism 105. An optical element may be, e.g., a lens, a detector, a mirror, a light source, an optical fiber, etc. The positioning projections 110 may serve to precisely position, e.g., passively align, the optical element(s) on the substrate 100 by providing, e.g., reference or boundary points for the precise alignment of the respective optical element to be positioned therewith. The micro-prism 105 may be restrained against movement about one or more of axes X, Y, and Z shown in FIG. 1A. The positioning projections 110 may be an integral part of the substrate 100 or may be made of a different material therefrom. The optical element(s) may be optically connected through the substrate 100.

The substrate 100 may include, e.g., transmissive material(s), and may be transparent to at least certain wavelengths of interest, i.e., predetermined wavelengths. More particularly, e.g., in some embodiments of the invention, the substrate 100 may be or may include, e.g., glass, e.g., fused quartz, fused silica, optical glass, Pyrex. However, embodiments of the invention are not limited to substrates 100 that are transmissive. For example, in some embodiments of the invention the substrate 100 may include opaque material(s), e.g., may be a silicon wafer. That is, the substrate 100 may include any material(s) on which the positioning projections 110 may be arranged and which is capable of supporting the optical element(s) thereon.

The substrate 100 may have a planar and/or substantially planar surface 101, and the positioning projections 110 may be arranged on the planar and/or substantially planar surface 101. Although a single planar and/or substantially planar surface 101 is shown in FIGS. 1A through 1C, embodiments of the invention are not limited thereto. For example, the substrate 100 may include a plurality of planar and/or substantially planar surfaces and some or all of the plurality of planar or substantially planar surfaces of the substrate 100 may include a plurality of positioning projections and one or more optical elements arranged thereon.

The positioning projections 110 may project from the planar and/or substantially planar surface 101 of the substrate 100. In some embodiments, e.g., all of the positioning projections 110 may project a same distance relative to the planar or substantially planar surface 101 of the substrate 100. In other embodiments, some or each of the positioning projections 110 may project a different distance from the planar or substantially planar surface 101 of the substrate 100. A distance that each positioning projection 110 extends away from the substrate 100, i.e., a height of the positioning projection 110 along the z-direction relative to the substrate 100, may be based on, e.g., a size, height and/or weight of the optical element being arranged on the substrate 100 in relation thereto, a number of the positioning projections 110 associated with one of the optical elements and/or a position of the positioning projection 110, i.e., characteristics of the respective portion of the optical element that the positioning projection 110 is to help position. That is, the positioning projections 110 may each be respectively sized to be at least thick enough, e.g., along the x-y plane, and tall enough, along the z-direction, to serve as a positioning structure for the respective optical element and/or to withstand any pressure that may be subjected thereon by the respective optical element.

In some embodiments of the invention, one or some of the positioning members 110 may be arranged on other ones of the positioning members 110. The positioning projections 110 may have various cross-sectional shapes along the x-y plane. For example, the positioning projections 110 may have a L-shaped, concave-shaped, convex-shaped, round, oval, polygonal, e.g., square, rectangular, triangular, octagonal, etc., cross-sectional shape along the x-y plane.

Referring to FIG. 1A, the positioning projections 110 may project, e.g., along a first direction, e.g., z-direction, relative to the planar and/or substantially planar surface 101. As shown in FIGS. 1A and 1C, the micro-prism 105 may be precisely arranged at a respective predetermined position on the planar and/or substantially planar surface 101 of the substrate 100 in accordance with the positioning projections 110 associated therewith.

As shown in FIG. 1B, the plurality of positioning projections 110 may define one or more predetermined spaces, i.e., footprints, on the substrate 100 where the micro-prism 105 may be arranged. More particularly, the plurality of positioning projections 110 may define a predetermined space 112 on the substrate 100 by, e.g., defining a boundary along a plane extending along second and third directions, i.e., x-y plane, within which the micro-prism 105 may be arranged, or by serving as edge stops for respective portions or edges of the micro-prism 105. For example, in some embodiments of the invention, a shape of the boundary defined by the positioning projections 110 may substantially correspond to a cross-sectional shape of a portion, e.g., lower portion, of the micro-prism that is to be arranged between the projecting portions 110. In other embodiments of the invention, when the optical element, e.g., the micro-prism 105, is arranged relative to the corresponding projecting portions 110, portions or sides of the micro-prism 105 may abut or be arranged adjacent to respective ones of the projecting portions 110 while other portion(s), e.g., corner(s), of the micro-prism 105 may extend outward beyond the projection portions 110. The predetermined spaces 112 may be defined in accordance with the optical functionality requirements and the optical bench 10 design requirements.

Referring to FIG. 1B, in some embodiments of the invention, an adhesive 115 may be provided on the substrate 100 in the predetermined space 112. The adhesive 115 may be employed to secure the micro-prism 105 to the substrate 100. The adhesive 115 may be provided at a portion of or all of the predetermined space 112. The adhesive 115 may be, e.g., a thermal or UV-curable epoxy. In such cases, e.g., after the micro-prism 105 is arranged on the predetermined space 112, the respective portion of the optical bench 10 may be thermally treated or exposed to UV light to cure the adhesive and fix the micro-prism 105 over the respective predetermined space 112.

Although the first exemplary embodiment is illustrated with the micro-prism 105 having a specific shape, embodiments of the invention are not limited to a micro-prism and/or a micro-prism having the shape shown in FIGS. 1A and 1C.

Further, although eight positioning projections 110 are illustrated in the exemplary embodiment of FIGS. 1A to 1C, embodiments of the invention are not limited to eight positioning projections 110. More particularly, e.g., two or more positioning projections 110 may be provided for arranging a single optical element, e.g., micro-prism 105. Also, in the first exemplary embodiment illustrated in FIG. 1, the positioning projections 110 are arranged so as to have two positioning projections 110 on each side of the micro-prism 105. However, embodiments of the invention are not limited to such an arrangement. For example, in some embodiments, only two positioning projections 110 may be provided and a portion of a first side of an optical element may, e.g., abut one of the two positioning projections 110 and a second side of the optical element may, e.g., abut a second side of the optical element. In such cases, the first side of the optical element may be opposite to the second side of the optical element.

Referring to FIGS. 1A, 1B and 1C, embodiments of the invention may provide the plurality of positioning projections 110 to align the micro-optical benches on the optical bench 10 without requiring any etching of the substrate 100. Accordingly, transmissive substrates, e.g., substrates that are generally difficult or slow to etch, may be used and embodiments of the invention may be employed in visible light applications. Further, embodiments of the invention may not be subjected to any positional orientation restrictions, e.g., restrictions resulting from the crystallographic orientation of the substrate.

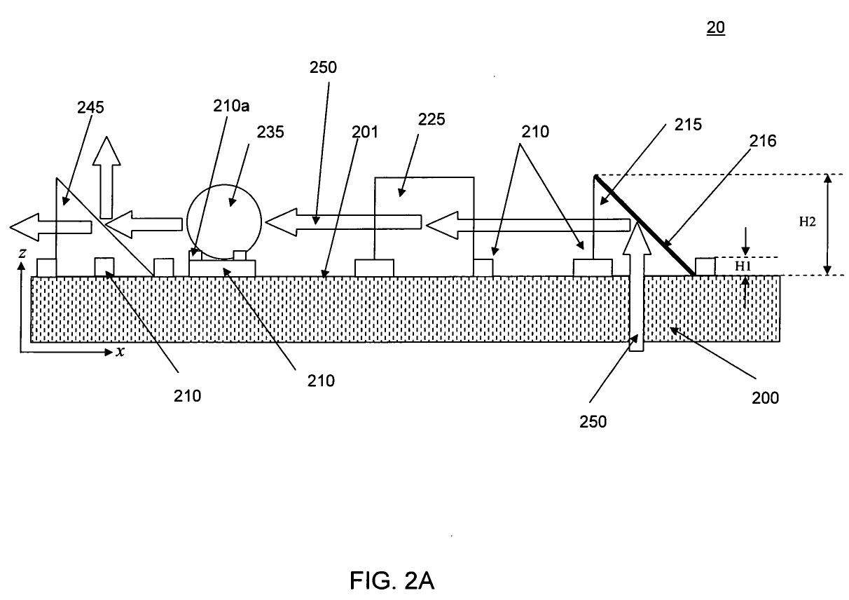

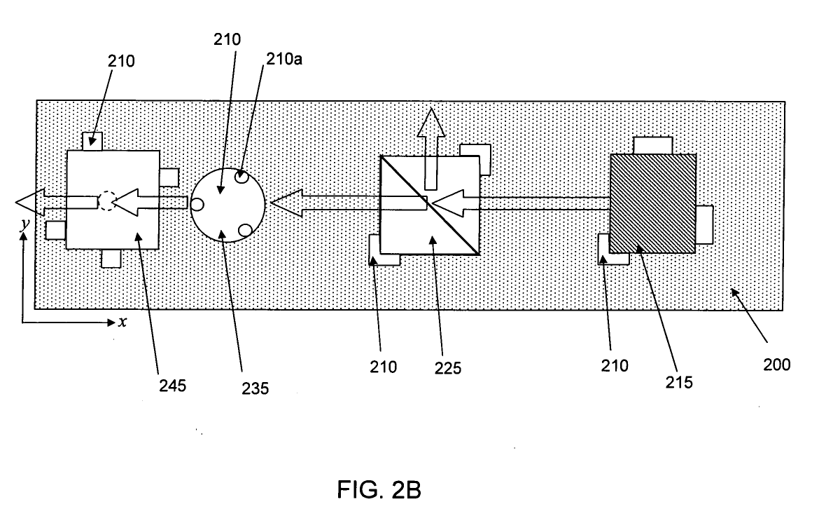

FIG. 2A illustrates a cross-sectional view of a second exemplary embodiment of an optical bench 20 in a state in which a plurality of optical elements are positioned thereon, and FIG. 2B illustrates a top plan view of the second exemplary embodiment of the optical bench 20 FIG. 2A.

As shown in FIGS. 2A and 2B, the second exemplary optical bench 20 may include a substrate 200, a plurality of positioning projections 210, and a plurality of optical elements, e.g., a prism 215, a beamsplitting cube 225, a ball lens 235 and a beamsplitting prism 245. Referring to FIG. 2A, the plurality of positioning projections 210 and the prism 215, the beamsplitting cube 225, the ball lens 235 and the beamsplitting prism 245 may be arranged on a planar and/or substantially planar surface of the substrate 200. The prism 215 may be a reflector with a metallic coating 216.

The arrows shown in FIGS. 2A and 2B illustrate an exemplary path 250 of light through opposing sides of the substrate 200 and further through the optical elements, e.g., the prism 215, the beamsplitting cube 225, the ball lens 235 and the beamsplitting prism 245.

Like the substrate 100 of the first exemplary embodiment, in some embodiments of the invention, the substrate 200 may be or may include opaque and/or transmissive material(s). For example, the substrate 200 may include, e.g., glass, e.g., fused quartz, fused silica, optical glass, Pyrex.

Referring to FIGS. 2A and 2B, any number of the positioning projections 210 may be arranged on the substrate 200 for positioning each of the optical elements. The positioning projections 210 may be arranged so as to abut or receive any portion, e.g., side portion or corner portion, of the respective optical element. For example, three positioning projections 210 may be arranged on the substrate 200 to define a predetermined space thereon for the prism 215. More particularly, e.g., two of the positioning projections 210 corresponding to the prism 215 may abut a respective side portion of the prism 215 and one of the positioning members 210 corresponding to the prism 215 may abut or receive a corner portion of the prism 215. Two positioning projections, e.g., one at two opposing corners, may be arranged on the substrate 200 to define a predetermined space thereon for the beamsplitting cube 225.

Four positioning members 210 may be arranged on the substrate 200 to define a predetermined space for the ball lens 235. More particularly, the optical bench 20 may include positioning projections 210 and second positioning projections 210a. The second positioning projections 210a may project from the positioning projections 210 arranged on the substrate 200. In such cases, the positioning projections 210 corresponding to the ball lens 235 may serve as a stage-like or propping-type positioning projection so as to enable the ball lens 235 to be aligned along the path 250 of light. That is, in some embodiments, e.g., when optical elements of different overall sizes are employed, the positioning projections, e.g., 210, 210a, may be stacked on each other or may project different distances from the substrate 200 to enable the respective optical element(s) to be aligned in accordance with the design standards of the optical bench 20.

Referring again to FIGS. 2A and 2B, four positioning projections 210 may be arranged on the substrate 200 to define a respective predetermined space for the beamsplitting prism 245. For example, one of the positioning projections 210 may be arranged to abut each side of the beamsplitting prism 245.

In embodiments of the invention, as discussed above, the arrangement, shape, size, height, etc., of each of the positioning projections 210 may depend on the design requirements of the optical bench, the shape of the respective optical element(s), the size of the respective optical element(s), etc. For example, a height H1 of at least one of the positioning projections 110 associated with the prism 215 may be based on a height H2 of the prism 215. The height H1 of at least one of the positioning projections 110 associated with the prism 215 may be an order of magnitude shorter than the height H2 of the prism 215. More particularly, e.g., referring to FIG. 2A, if the height H2 of the prism 215 is about 0.3 mm to about 3.0 mm, the height H1 of at least one of or all of the corresponding positioning projections 110 may be about 50 μm to about 500 μm.

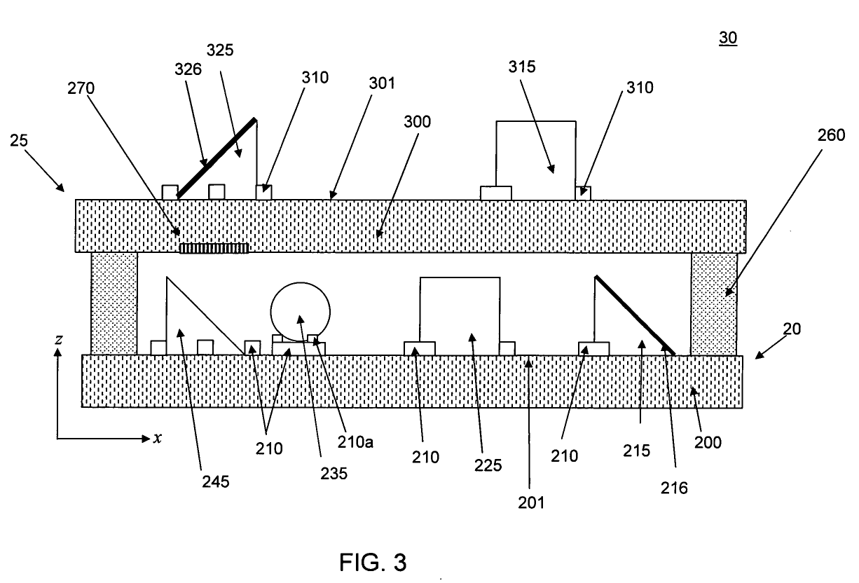

FIG. 3 illustrates a cross-sectional view of a third exemplary embodiment of an optical bench 30 in a state in which a plurality of optical elements are positioned thereon. More particularly, the optical bench 30 may be a multi-layered optical bench including the second exemplary optical bench 20 described above as one layer thereof and a second optical bench 25 as a layer stacked on the optical bench 20.

The second optical bench 25 may include a substrate 300 with a plurality of positioning projections 310, and a plurality of optical elements, e.g., a beamsplitting cube 315 and a prism 325, arranged on, e.g., a substantially planar or planar surface 300 thereof. The prism may be coated with a reflectively, e.g., metallic, layer 326. A diffractive optical element 270 may be etched in the substrate 300. In cases in which the substrate 300 is a transmissive substrate, light may be transmitted from the optical bench 20 up toward the optical elements 315, 325 on the second optical bench 30.

As shown in FIG. 3, bonding spacers 260 may be arranged between the optical bench 20 and the second optical bench 25. A height of the bonding spacers 260 may be taller than a height of the tallest one of the optical elements on the optical bench 20 relative to the substrate 200 thereof. The bonding spacers 260 may be, e.g., polymer spacers. Positions of the bonding spacers on the substrate 200 and/or a number of spacers 260 may be based on mechanical design requirements of the optical bench 30. For example, pre-existing planar refractive or diffractive components in the substrate(s) 200, 300 may be considered when placing the positioning projections 210, 310. Although only two layers are shown in FIG. 3, micro-optical benches according to one or more aspects of the invention may have more than two layers, i.e., more than two stacked substrates.

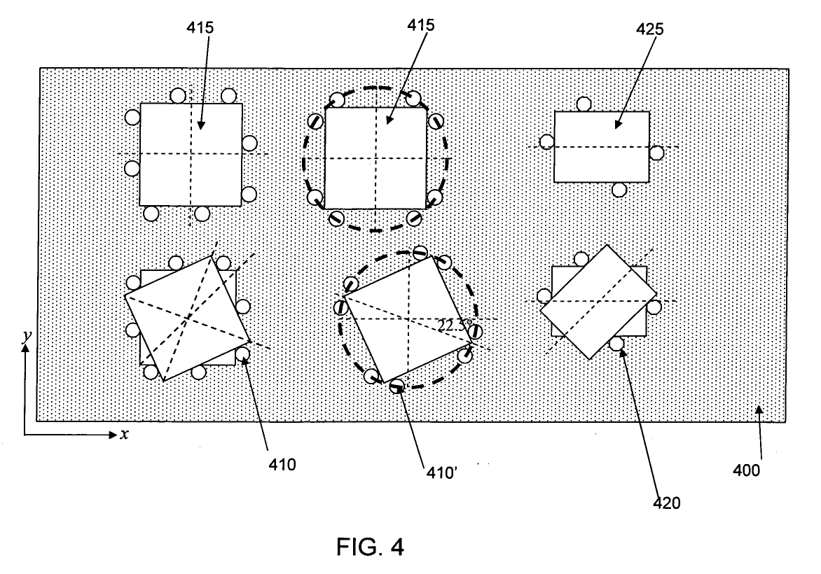

FIG. 4 illustrates a top plan view of an exemplary surface showing exemplary arrangement patterns of positioning projections 410, 410′, 420.

More particularly, FIG. 4 illustrates first and second optical elements 415, 425 arranged on a substrate 400 in relation to first and second positioning projections 410, 410′ and 420, respectively.

As discussed above, the positioning projections 410, 410′, 420 may have various cross sectional shapes along the x-y plane. For example, the first positioning projections 410, 410′ may have circular cross sectional shapes along the x-y plane, and the second positioning projections 420 may have an octagonal cross sectional shape along the x-y plane.

FIG. 4 illustrates two exemplary arrangement patterns for the first positioning projections 410, 410′ in relation to the first optical element 415. More particularly, the illustrated arrangement pattern of the first positioning projections 410 may enable the first optical element 415 to be arranged in at least at two different positions relative to the substrate 400, i.e., where the first optical element is arranged with different rotational positions relative to the first positioning projections 410, while the first positioning projections 410 are arranged at a same position on the substrate 400. The illustrated arrangement pattern of the first positioning projections 410′ may also enable the first optical element 415 to be arranged at least at two different positions relative to the substrate 400. More particularly, by rotating a position of the first positioning projections 410′ relative to the substrate 400, the first optical element 415 may also be arranged in different positions relative to the substrate 400.

With regard to the second positioning projections 420 and the second optical element 425, the second positioning projections 420 may allow the second optical element 425 to be arranged at least at two different positions relative to the substrate 400. More particularly, the octagonal cross sectional shape of the second positioning projections 420 may ensure more precise positioning of the second optical element relative to the second positioning projections 420 and the substrate 400. Different arrangements of the second optical member 425 may be achieved while the second positioning projections 20 are at the same positions relative to the substrate 400.

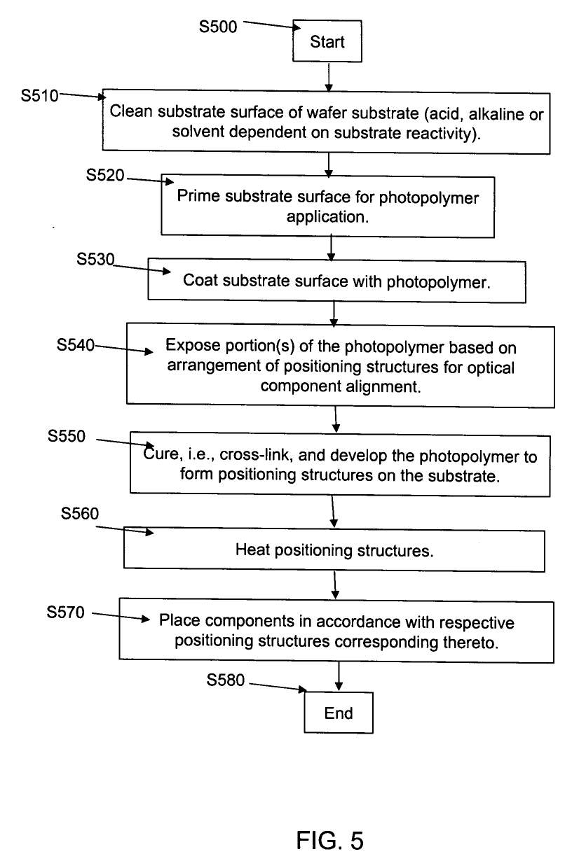

The positioning projections may be made of any material having sufficient material strength and chemical resistance, and may be made by any process capable of realizing both the aspect ratio and the absolute dimensions thereof. For example, the positional projections may be a polymer or a polymeric vitreous material, e.g., a photopolymer that may be patterned using photolithography, as discussed below with respect to FIG. 5.

FIG. 5 illustrates a flow chart of stages in an exemplary process of forming an optical bench.

Referring to FIGS. 1 through 5, the process may begin in step S500, and may proceed to step S510. During step S520, a substrate, e.g., 100, 200, 300, 400, may be cleaned. The substrate may be cleaned using a material, e.g., a solvent, an acid and/or an alkaline, suitable for the material(s) of the substrate. Next, during step S520, a surface, e.g., 101, 201, 301, of the substrate may be primed to prepare for photopolymer application.

Next, during step S530, the primed surface may be coated with a photopolymer, e.g., a negative-tone photoresist such as SU-8, to form the positioning projections using lithographic techniques. A thickness of the photopolymer on the substrate may be based on a height of the positioning projections, e.g., 110, 210, 210a, 310, 410, 410′, 420, to be formed on the substrate, i.e., in accordance with design requirements of the optical bench, e.g., 10, 20, 25, 30.

Next, during step S540, portion(s) of the deposited photopolymer may be exposed using, e.g., UV light, based on the desired positions of the positioning projections.

Next, during step S550, the patterned photopolymer may be subjected to a cross-linking process and may be developed to form the positioning projections.

Next, during step S560, the formed positioning projections may be subjected to a heating process. The heating process may help ensure that the formed positioning projections are permanently shaped and fixed to the substrate.

Next, during step S570, optical elements may be arranged on the substrate in relation to the respective positioning projections formed on the substrate. The process may end in step S580.

In some embodiments, prior to depositing a material for forming the projecting portions, e.g., photopolymer, and more particularly, e.g., SU8, an adhesion promoter may be applied on the substrate, e.g., glass, silicon wafer, to aid in the adhesion of the material to the substrate. For example, in embodiments in which the photopolymer is, e.g., SU8, and the substrate is glass or a silicon wafer, hexamethyldisilazane (HMDS) may be deposited therebetween as an adhesion promoter for promoting adhesion between the SU8 and the glass or silicon wafer.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A micro-optical bench, comprising:
a substrate having a substantially planar surface on which an optical element is to be mounted; and
two positioning projections protruding above the substantially planar surface adapted to position and restrain movement of the optical element.

2. The micro-optical bench as claimed in claim 1, wherein the two positioning projections define a footprint for the optical element.

3. The micro-optical bench as claimed in claim 2, wherein, when the optical element is on the substrate, each of the positioning projections abuts the optical element.

4. The micro-optical bench as claimed in claim 3, wherein the positioning projections each abut opposing faces of the optical element.

5. The micro-optical bench as claimed in claim 3, wherein the positioning projections each abut adjacent faces of the optical element.

6. The micro-optical bench as claimed in claim 3, wherein the two positioning projections include a plurality of lithographs, each lithograph abutting a different face of the optical element adjacent the substrate.

7. The micro-optical bench as claimed in claim 6, wherein two positioning projections of the plurality of positioning projections abut each different face of the optical element adjacent the substrate.

8. The micro-optical bench as claimed in claim 1, wherein the two positioning projections allow the optical element to be positioned in at least two rotational positions.

9. The micro-optical bench as claimed in claim 8, wherein each positioning projections is adjacent to one side of the optical element at each rotational position.

10. The micro-optical bench as claimed in claim 1, wherein the two positioning projections are made of a polymer or a polymerizing vitreous material.

11. The micro-optical bench as claimed in claim 1, wherein the two positioning projections are integral with the substrate.

12. The micro-optical bench as claimed in claim 1, wherein the positioning projections is transparent to wavelengths of interest.

13. The micro-optical bench as claimed in claim 1, wherein the optical element is optically connected through the substrate.

14. The micro-optical bench as claimed in claim 1, wherein the substrate includes a plurality of substantially planar surfaces on which corresponding optical elements are to be mounted, and the two positioning projections include two positioning projections adjacent each of the corresponding optical elements.

15. The micro-optical bench as claimed in claim 14, wherein the plurality of substantially planar surfaces form a continuous substantially planar surface.

16. The micro-optical bench as claimed in claim 1, wherein at least one of the positioning projections has one of a circular cross-sectional shape, an oval cross-sectional shape and a polygonal cross-sectional shape.

17. The micro-optical bench as claimed in claim 1, further comprising an adhesive layer between the substrate and the optical element.

18. The micro-optical bench as claimed in claim 1, further including a second substrate overlapping at least a portion of the substrate and spaced apart from the substrate by a predetermined distance corresponding to a height of bonding spacers arranged between the substrate and the second substrate, wherein the second substrate includes a substantially planar surface on which an optical element is to be mounted.

19. The micro-optical bench as claimed in claim 1, wherein the two positioning projections include a plurality of positioning projections and at least one of the plurality of positioning projections projects a further distance away from the substrate than others of the plurality of positioning projections.

20. The micro-optical bench as claimed in claim 1, wherein at least one of the two positioning projections is a lithograph.

21. The micro-optical bench as claimed in claim 1, wherein the positioning projections are made of a different material than the substrate.

22. The micro-optical bench of claim 1, wherein at least one of the plurality of positioning projections extends between about 50 μm and about 500 μm above the substrate.

23. A micro-optical bench, comprising:
a substrate having a substantially planar surface on which an optical element is to be mounted; and
a plurality of positioning projections protruding above and substantially perpendicular to the substantially planar surface adapted to position and restrain movement of the optical element about a plurality of axes, the positioning projections being constructed of a different material than the substrate.

24. The micro-optical bench of claim 22, wherein at least one of the plurality of positioning projections extends between about 50 μp and about 500 μm above the substrate.

25. A method of manufacturing an optical bench, comprising:
providing a photopolymer layer on a surface of a substrate;
exposing a portion of the photopolymer layer based on a position of at least two positioning projections to be formed on the substrate, the positioning projections being positioned so as to define a predetermined space on the optical bench where an optical element is to be mounted;
curing and developing the photopolymer layer to form the at least two positioning projections; and
thermally treating the at least two positioning projections.
